(19) United States
(12) Patent Application Publication
(10) Pub. No.: US 2013/0069440 A1
(43) Pub. Date: Mar. 21, 2013

(54) INCOMING CIRCUIT USING MAGNETIC RESONANT COUPLING

(71) Applicants: Takao MARUKAME, Tokyo (JP); Hirotaka NISHINO, Yokohama-shi (JP); Masamichi SUZUKI, Tokyo (JP); Atsuhiro KINOSHITA, Kamakura-shi (JP)

(72) Inventors: Takao MARUKAME, Tokyo (JP); Hirotaka NISHINO, Yokohama-shi (JP); Masamichi SUZUKI, Tokyo (JP); Atsuhiro KINOSHITA, Kamakura-shi (JP)

(73) Assignee: KABUSHIKI KAISHA TOSHIBA, Tokyo (JP)

(21) Appl. No.: 13/537,144

(22) Filed: Jun. 29, 2012

(30) Foreign Application Priority Data
Sep. 20, 2011 (JP) 2011-205312

(51) Int. Cl. H02J 17/00

(52) U.S. Cl. 307/104

(57) ABSTRACT

According to one embodiment, an incoming circuit using a magnetic resonant coupling includes an incoming coil which receives magnetic field energy transmitted from an outgoing coil under conditions of energy power transmission by the magnetic resonant coupling, and an incoming circuit which comprises a variable capacitor and a rectifier circuit and which outputs, as a direct-current voltage, the magnetic field energy received by the incoming coil. A capacitance of the variable capacitor is automatically controlled to change in an analog form along with the change of the direct-current voltage and to keep the transmission efficiency of the magnetic field energy at a fixed value by directly feeding back the direct-current voltage to the variable capacitor.

### CROSS-REFERENCE TO RELATED APPLICATIONS

This application is based upon and claims the benefit of priority from prior Japanese Patent Application No. 2011-205312, filed Sep. 20, 2011, the entire contents of which are incorporated herein by reference.

### FIELD

Embodiments described herein relate generally to an incoming circuit using a magnetic resonant coupling.

### BACKGROUND

A technique that uses electromagnetic induction and a technique that uses electromagnetic waves are generally known as techniques for supplying electromagnetic energy by radio. For example, a non-contact IC card operates by a wireless power transmission/receiving technique using electromagnetic induction. The electromagnetic induction method permits electric power to be relatively efficiently transmitted up to a distance which is about one tenth of a coil diameter, but is not suitably used for greater distances because of increased damping.

In the meantime, microwave electric power transmission has been studied as a technique for a long-distance electromagnetic energy transmission. Microwaves may affect the human body due to strong directivity and strong energy radiation, and are therefore limited in application.

Thus, the wireless electric power transmission by the electromagnetic energy has a trade-off relation between the distance and the power transmission efficiency. Accordingly, a technique using a magnetic resonant coupling has recently been suggested.

According to the wireless power supply technique that uses the magnetic resonant coupling, the resonant frequency of an outgoing coil and the resonant frequency of an incoming coil are set at the same value to transfer electric power. By tuning these resonant frequencies to each other, a magnetic coupling that allows high-efficiency energy transfer by the magnetic resonance is generated between an outgoing circuit and an incoming circuit, and electric power is transferred by radio from a resonator of the outgoing circuit to a resonator of the incoming circuit. As a result, electric power can be transferred at a high efficiency of several ten percent, for example, within a distance of about several ten centimeters to several meters.

Thus, the magnetic resonant coupling is known to use the magnetic field and therefore have a relatively small effect on the human body. Moreover, the magnetic resonant coupling is drawing much attention and expected to come into practical use as a technique that fills a gap between the distance and the power transmission efficiency of the conventional electromagnetic induction method and the microwave electric power transmission.

However, in order to put the magnetic resonant coupling into practical use, it is necessary to always maintain a resonant condition. To this end, a circuit system that adjusts capacitors of the resonators to match the resonant frequencies is under study. In this case, however, the scale of the incoming circuit is increased.

### BRIEF DESCRIPTION OF THE DRAWINGS

FIG. 1 is a diagram showing a wireless power transmission/receiving system using a magnetic resonant coupling;

FIG. 2 is a diagram showing conditions for the electric power transmission/receiving using the magnetic resonant coupling;

FIG. 3 is a diagram showing an incoming circuit used for the transient analysis of an output DC voltage;

FIG. 4 and FIG. 5 are graphs showing analytic results of the output DC voltage;

FIG. 6 is a diagram showing a first example of the incoming circuit;

FIG. 7 is a diagram showing the device structure of a resonant capacitor in FIG. 6;

FIG. 8 is a diagram showing a second example of the incoming circuit;

FIG. 9 is a diagram showing the device structure according to a third example of the incoming circuit;

FIG. 10 is a diagram showing a fourth example of the incoming circuit;

FIG. 11 is a diagram showing the device structure of a resonant capacitor in FIG. 10;

FIG. 12 is a diagram showing a fifth example of the incoming circuit;

FIG. 13 is a diagram showing the device structure of a resonant capacitor in FIG. 12;

FIG. 14 is a diagram showing the device structure according to a sixth example of the incoming circuit;

FIG. 15 is a diagram showing a seventh example of the incoming circuit;

FIG. 16 is a diagram showing the device structure of a resonant capacitor in FIG. 15;

FIG. 17 is a diagram showing the device structure according to an eighth example of the incoming circuit; and

FIG. 18 is a diagram showing the device structure according to a ninth example of the incoming circuit.

### DETAILED DESCRIPTION

In general, according to one embodiment, an incoming circuit using a magnetic resonant coupling comprises: an incoming coil which receives magnetic field energy transmitted from an outgoing coil under conditions of energy power transmission by the magnetic resonant coupling; and an incoming circuit which comprises a variable capacitor and a rectifier circuit and which outputs, as a direct-current voltage, the magnetic field energy received by the incoming coil. The magnetic field energy is converted to an alternate-current voltage by the incoming coil and the variable capacitor, and the alternate-current voltage is converted to the direct-current voltage by the rectifier circuit. A capacitance of the variable capacitor is automatically controlled to change in an analog form along with the change of the direct-current voltage and to keep the transmission efficiency of the magnetic field energy at a fixed value by directly feeding back the direct-current voltage to the variable capacitor.

Hereinafter, an embodiment will be described with reference to the drawings.

The embodiment concerns an incoming circuit of a wireless power transmission/receiving system which uses a magnetic resonant coupling to supply electric power by ratio. According to the incoming circuit of the embodiment, the operation for matching resonant frequencies in real time to maintain a resonant condition can be performed under automatic control to always keep a constant transmission efficiency of energy transmitted by magnetic resonance. This allows for a wireless power supply system capable of high-efficiency and long-distance electric power transmission. Moreover, the incoming circuit has a simple configuration and can be formed by an LSI technique, and can therefore contribute to the size reduction of the system.

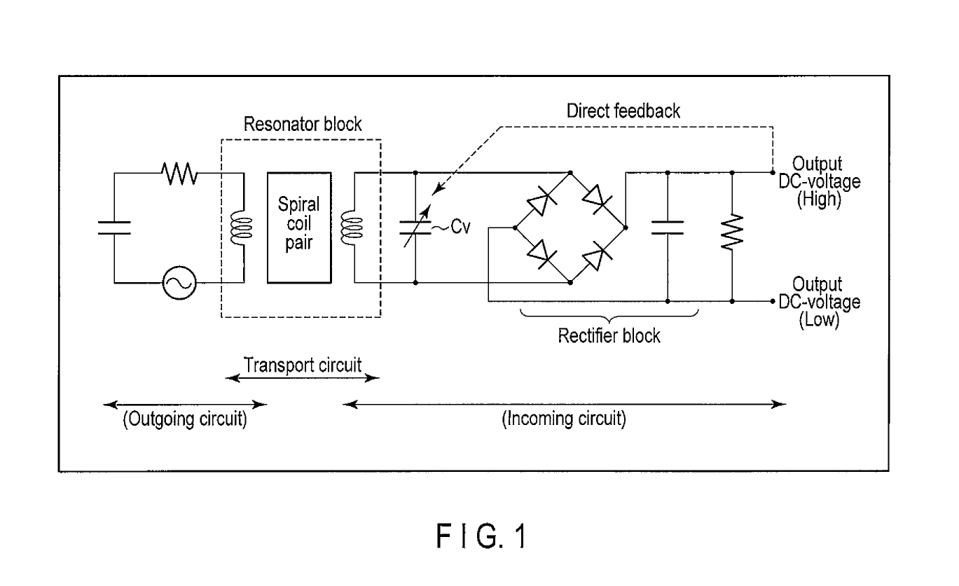

The wireless power supply system according to the embodiment has the overall configuration shown in FIG. 1, and is characterized by the incoming circuit. That is, the wireless power supply system is characterized in that the capacitance of resonant capacitor (variable capacitor) Cv of the incoming circuit is directly controlled by its output DC voltage. Here, “to be directly controlled” means that the output DC voltage is directly fed back to resonant capacitor Cv without the intervention of a control unit such as a controller.

Here, it is possible to easily consider a technique that uses the control unit to judge the output DC voltage and control the capacitance of resonant capacitor Cv. However, this technique is not applicable to a magnetic resonant coupling wireless power supply technique that requires real-time following performance. The reason is that in a system in which the positional relation between an outgoing circuit and an incoming circuit randomly changes, for example, during electric power supply, electric power has to be instantaneously supplied, while electric power cannot be sufficiently supplied if the operation of matching the resonant frequencies is slow.

Thus, the incoming circuit according to the embodiment is characterized in that the capacitance of resonant capacitor Cv is controlled in real time by directly using its output DC voltage. Accordingly, a high power transmission efficiency can be always maintained regardless of the positional relation between the outgoing circuit and the incoming circuit.

The magnetic resonant coupling incoming circuit according to the embodiment resembles the conventional electromagnetic induction incoming circuit, but completely differs in the conditions for high-efficiency electric power supply. Therefore, the principle of a prerequisite magnetic resonant coupling is described in detail.

<Principle and Point of Magnetic Resonant Coupling>

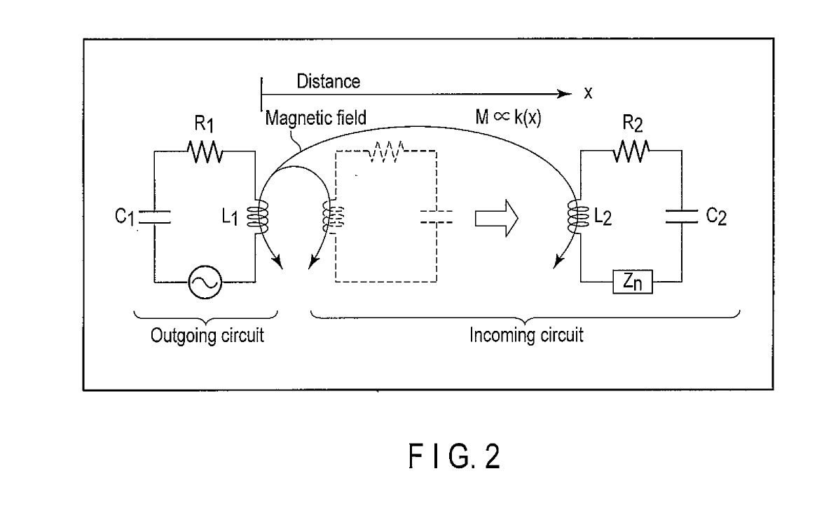

As shown in FIG. 2, the basic principle of the magnetic resonant coupling is an LC coupling between a resonator of an outgoing circuit and a resonator of an incoming circuit.

A magnetic resonant coupling configuration that is first verified uses a resonance phenomenon occurring between central two coils called “spiral coils” or “resonant coils”. Electric power generated by a high-frequency power supply is transmitted to the outgoing coil (resonant coil) of the outgoing circuit via a normal electromagnetic induction coil. The electromagnetic induction coil is also called a loop coil. The incoming circuit receives electric power by the incoming coil (resonant coil), and supplies the electric power to a load via the electromagnetic induction coil.

Here, high power transmission efficiency can be obtained by matching the resonant frequency of a resonant circuit of the outgoing circuit with the resonant frequency of a resonant circuit of the incoming circuit. The resonant frequency of the resonant circuit is determined by the product of the inductance of the resonant coil and the capacitance of a resonant capacitor.

In general, the power transmission efficiency of the magnetic resonant coupling often indicates the efficiency between two resonant coils. However, it is actually necessary to optimally design a system that allows high power transmission efficiency in the whole system including electromagnetically inducted parts.

Accordingly, the embodiment particularly suggests a technique for enhancing the efficiency in the incoming circuit.

The index of power transmission efficiency is the product k×Q of energy Q stored in two resonant coils and a coupling coefficient k of the two resonant coils. The coupling coefficient k is a proportionality coefficient of mutual inductance M between the two resonant coils. More specifically, the coupling coefficient k has the relation of Equation (1):

k=M/(√(L1·L2)) (1)

wherein L1 is the self-inductance of the outgoing coil of the outgoing circuit, L2 is the self-inductance of the incoming coil of the incoming circuit, and M is the mutual inductance.

Moreover, Q is ωL/R in the case of a series resonator. ω is a frequency during resonance. k×Q is ωM/R when self-inductances L1 and L2 of two resonators are respectively equal to resistances R1 and R2. However, L=L1=L2, and R=R1=R2.

That is, power transmission efficiency is higher when the coupling coefficient k between the two resonant coils is higher and the resistance R of each resonator is lower. However, this is the result for a simplified system. Actually, factors correlate with one another.

While the coupling coefficient k depends on the distance and dynamically changes with use conditions, the energy Q stored in the two resonant coils is determined at the stage of designing the resonant circuit if a frequency band used for electric power transmission is determined.

Energy input to the outgoing coil from a power supply circuit is lost by a resistance component of the outgoing coil and resistance (radiation resistance) contributing to far radiation. If resonance conditions are set, a high power transmission efficiency of more than 90 percent is obtained. To increase the energy Q, the inductance L can be increased, and loss in the resistance component and a component radiating to a distance can be decreased.

Basically, the outgoing coil and the incoming coil can be increased in diameter and in the number of winding to increase the inductance L. However, the resistance R increases in proportion to the numbers of winding of the outgoing coil and the incoming coil, the inductance L and the resistance R need to be properly balanced. The resistance R is also frequency-dependent due to a skin effect.

If the frequency band (resonant frequency) used for electric power transmission is determined at the time of designing, the product of the inductance L and capacitance C is determined by the relation in Equation (2):

f=(√(LC))×½π (2).

Here, the energy Q that is high means that variations of the inductance and capacitance of the outgoing/incoming coil have a great influence on the variation of the energy Q. Therefore, in the actual manufacture of the outgoing circuit and the incoming circuit, it is important to inhibit their manufacture variations and changes with time to maintain high energy Q.

In fact, for example, in the application to small-sized equipment, the incoming coil is incorporated in an incoming device, so that it is extremely difficult to obtain sufficient inductance and capacitance while reducing the coil size. Another problem is the low efficiency of the power supply circuit for generating high-frequency electric power in the outgoing circuit and of a rectifier circuit for converting the high-frequency electric power to a direct current in the incoming circuit.

This is in principle a resonance method that allows a high power transmission efficiency to be obtained. However, if the incoming device is moved or changed in direction while the outgoing coil and the incoming coil are coupled with each other, the mutual reactance changes, and the resonant frequency changes.

As a result, impedance on the side of a load when viewed from the power supply changes. How to compensate for this is an issue. The coupling coefficient k changes with the changes of the relative position and the power transmission distance, and the mutual inductance between the coils changes, so that the resonant frequency changes.

In order to solve this problem, studies have been carried out on a method which adjusts the inductance L or capacitance C of the incoming circuit to offset the change of the resonant frequency, a method which adjusts the distance between the resonant coil and the electromagnetic induction coil (a method which adjusts the coupling coefficient k), and a method which compensates for the change of the resonant frequency by the change of the power supply frequency.

Among these methods, the embodiment uses the method which adjusts capacitance C of the incoming circuit to offset the change of the resonant frequency. This method is simplest and capable of controlling the resonant frequency with accuracy and at high speed (in real time), and is thus used.

According to Equation (2), the resonant frequency depends on the inductance L and capacitance C. According to Equation (1), it seems that a higher power transmission efficiency is obtained when ω=2πf=1/√(LC) is higher.

However, L×C needs to be decreased to increase 1/√(LC). If the inductance L decreases, the distance dependence of the coupling coefficient k between the two resonant coils changes. When the distance increases, the coupling coefficient k decreases, and the mutual inductance M changes. The magnitude of L depends on the coil size, and a quantitative relation is experimentally and analytically obtained in the magnitude of L and the distance dependence of the coupling coefficient k.

That is, when the coil size is smaller, the absolute value of the mutual inductance M is smaller, and the strong damping of the mutual inductance M starts from a smaller distance. Thus, the mutual inductance M and the coupling coefficient k are determined by the inter-coil distance at each coil size, and it is essentially difficult for a small coil to increase distance.

If the number of winding of the coil is increased, the mutual inductance M increases, but the self-inductance L also increases, so that the coupling coefficient k hardly changes. Therefore, the coil size can be regarded as physically dominating the distance dependence of the coupling coefficient k. For example, it is suggested that in the case of an LSI chip of no more than several centimeters square, using the coil in the chip for electric power transmission within a distance equal to or more than the chip size is difficult.

In contrast, the magnetic resonant coupling allows a high power transmission efficiency if the conditions are set. In turn, the magnetic resonant coupling is easily affected by disturbance such as displacement.

An analysis formula for the power transmission efficiency between two LC resonators is represented by Equation (3):

S21=(2jMZω)/{(Mω)²+((Z+R)+j(ωL−1/ωC))²}² (3)

S21 is a constant of transfer from an outgoing unit to an incoming unit in high-frequency electric power transmission, and the square of the absolute value of S21 is the power transmission efficiency. It is appreciated that a high power transmission efficiency is obtained within the range of the proper coupling coefficient (i.e., distance) k. It is also appreciated that if the behavior at the fixed inductance L and the decreased capacitance C is found in Equation (3), the optimum value of the coupling coefficient k shifts to smaller values along with the decrease of capacitance C regarding the distance dependence of the power transmission efficiency.

That is, in order to obtain a high power transmission efficiency, it may be convenient for the magnetic resonant coupling to increase the distance between the two resonant coils rather than to decrease the distance. Such behavior is fundamentally different from the conventional electromagnetic induction method. It is not always appropriate to decrease capacitance C and thus increase a frequency f to gain a distance. The reason is that a coil of a certain size generates corresponding parasitic capacitance and the reduction of capacitance C is therefore limited.

After all, a realistic coil size is first determined once a frequency is determined, and then a structure to compensate for the variation range of capacitance C needs to be formed so that the absolute value of capacitance C of the resonant capacitor is taken into consideration.

The formation of the resonant circuit within the LSI chip is advantageous to the ease of designing and to the control of variations. On the other hand, the resonant coil does not have to be an on-chip coil within the LSI, and long-distance power transmission is possible if a large resonant coil is provided outside the chip.

<Principle of Resonance Feedback by Capacitance>

If the control of the magnetic resonance by the change of the coupling coefficient k and capacitance C of the resonant coil is analyzed by an electronic circuit simulator using an equivalent circuit, the split of resonance peaks due to the changes of the coupling coefficient k or capacitance C can be recognized. This split of the resonance peaks results from the difference of impedance, and causes the decrease of the power transmission efficiency.

Thus, it is necessary to properly control capacitance C of the resonant capacitor to compensate for the difference of the coupling coefficient k. According to this analysis, a spiral coil pair and the outgoing unit/incoming unit influence the whole system, so that the change of the incoming unit also influences the power transmission efficiency.

That is, even if high-efficiency electric power transmission is achieved between the resonant coils, the loss of electric power in the rectifier circuit of the incoming unit leads to low power transmission efficiency in the whole system. Moreover, in general, electric power is transmitted by an alternating current, and the electric power is used after the conversion of an alternate-current voltage to a direct-current voltage.

An AC voltage-DC voltage converter which performs this conversion, that is, the rectifier circuit comprises a diode bridge including diodes. Each of the constituent diodes affects the resonant capacitor due to its parasitic component and the dependence of its capacitance on the voltage.

Accordingly, the embodiment suggests an LC resonator which allows the self-aligning real-time compensation of the direct-current voltage output from the incoming circuit, that is, resonant capacitance changing with the output DC voltage, in the incoming circuit having the AC voltage-DC voltage converter, that is, the rectifier circuit.

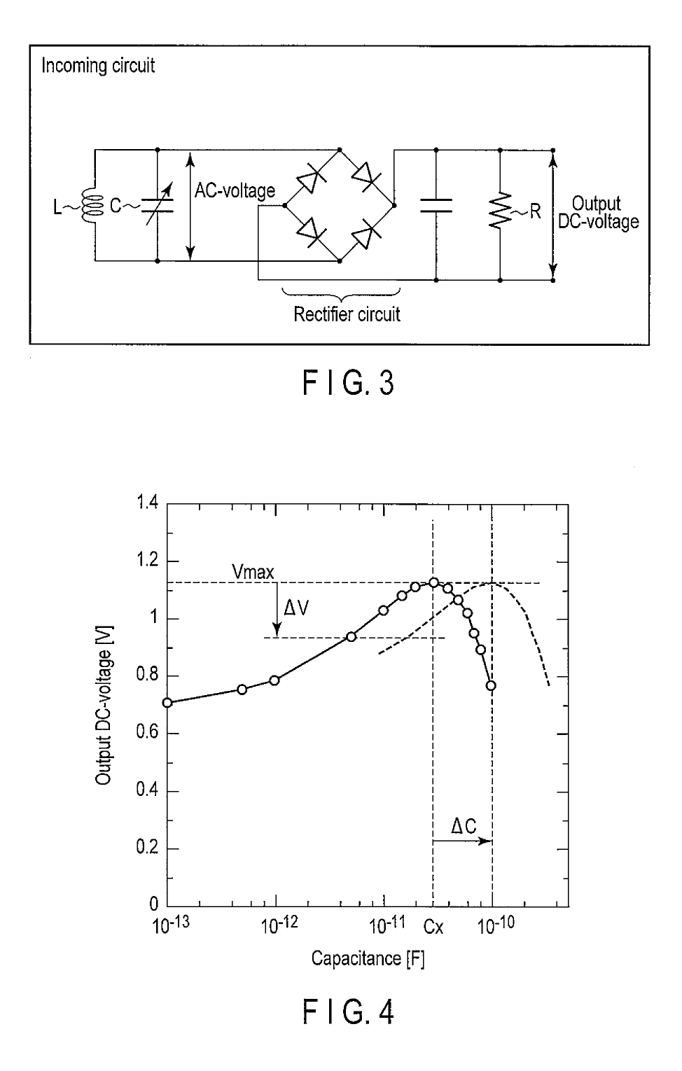

As shown in FIG. 3, the inductance L, capacitance C, and the resistance R are properly set in the incoming circuit having the LC resonator and the rectifier circuit, and capacitance C is used as a parameter for the transient analysis of the output DC voltage by the electronic circuit simulator. Here, amplitude is forcibly applied to the AC voltage to examine the characteristics of the incoming circuit.

FIG. 4 shows the analytic results.

It is found out from FIG. 4 that the output DC voltage changes by changing the value of capacitance C of the resonant capacitor when the outgoing circuit and the incoming circuit are coupled at the resonant frequency f. Capacitance Cx that allows maximum output DC voltage Vmax to be obtained is also present.

According to the results, not only capacitance C of the LC resonator but also the parasitic capacitances of the diode bridge and a smoothing capacitor added to the rectifier circuit are taken into consideration, and the value of the output DC voltage is considered to be influenced thereby.

Thus, control is performed to bring capacitance C of the resonant capacitor to Cx so that maximum output DC voltage Vmax is always obtained.

Capacitance Cx that allows maximum output DC voltage Vmax to be obtained also changes when the frequencies f in the two LC resonators change, for example, when the positional relation between the outgoing circuit and the incoming circuit changes.

Therefore, capacitance C of the resonant capacitor is matched with Cx in real time by a direct feedback mechanism of the output DC voltage in order to always match the frequencies f of the two LC resonators and obtain maximum output DC voltage Vmax.

More specifically, the following method is used.

In FIG. 4, if attention is focused on the range lower than capacitance Cx, the capacitance and the output DC voltage have a linear relationship (one-to-one relationship).

Thus, a three-terminal variable capacitor is used as the resonant capacitor, and the output DC voltage is set at an input value for controlling capacitance C of the resonant capacitor. Moreover, capacitance Cx that allows maximum output DC voltage Vmax to be obtained is set as the maximum value. Control is performed so that capacitance C is increased by ΔC when the output DC voltage drops by ΔV as compared with Vmax.

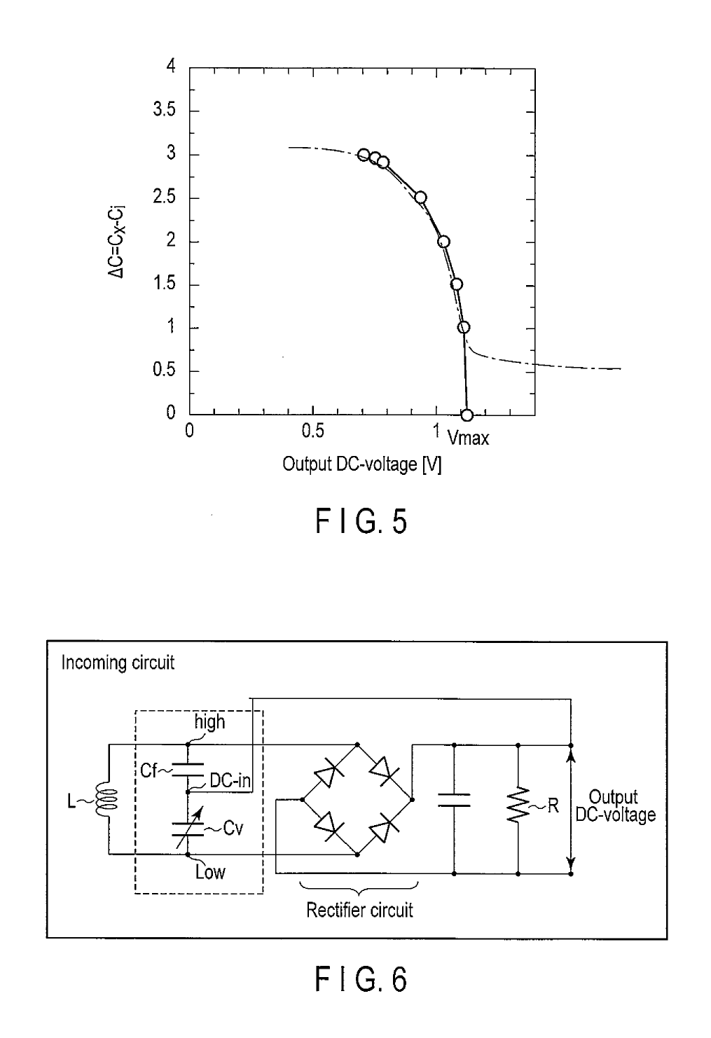

FIG. 5 shows the relation of FIG. 4 in a range lower than Cx.

Cx is the optimum value of the capacitance, and corresponds to Cx in FIG. 4. Ci is current capacitance, and ΔC is Cx−Ci. That is, when the resonant frequency f changes and the output DC voltage drops as compared with Vmax, control is performed to bring ΔC generated by the drop of the output DC voltage to zero or closer to zero to obtain maximum output DC voltage Vmax.

This control can be performed, for example, by using the characteristics of a MOS capacitor. In FIG. 5, a solid line indicates the relation of FIG. 4 in the range lower than Cx, and a dashed line indicates the characteristics of the MOS capacitor.

The device structure of the MOS capacitor fulfilling such characteristics will be described later.

The concept of the embodiment is designed so that when the output DC voltage drops from Vmax, capacitance Ci automatically increases, and AC is brought to zero accordingly, and the output DC voltage is thereby restored to Vmax. Actually, capacitance Ci immediately starts to increase when the output DC voltage shows a tendency to drop, so that it may be considered that the output DC voltage is designed to be always kept at Vmax.

It is proper to say that this method is designed to always maximize energy efficiency obtained by the incoming circuit rather than to fix the output DC voltage.

In order to merely fix the output DC voltage, a Zener diode can be added to an output terminal to forcibly fix the output DC voltage. In this case, energy is lost due to a current running through the Zener diode. In the meantime, the embodiment provides the technique that always sets the output DC voltage at Vmax by real-time control to always maximize the energy efficiency.

Semiconductor elements and circuit configurations suitable to obtain such automatic feedback of resonant capacitance are described below.

### First Example

FIG. 6 shows a first example.

In this example, an LC resonant circuit comprises fixed capacitor Cf and variable capacitor Cv that are connected in series between two nodes high and low. The output DC voltage is directly input to connection node (floating node) DC-in between fixed capacitor Cf and variable capacitor Cv. Coil (inductance) L of the LC resonant circuit is connected in parallel to capacitors Cf and Cv between two nodes high and low.

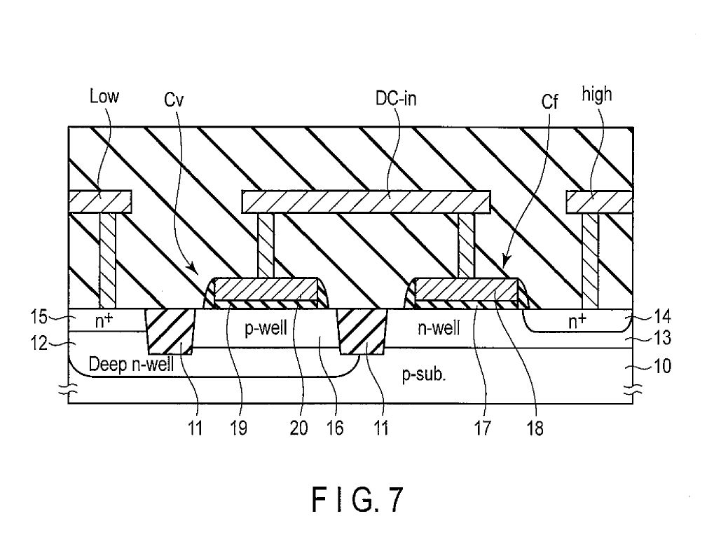

FIG. 7 shows an example of the device structure of a part indicated by a broken line in FIG. 6, that is, capacitors Cf and Cv constituting the LC resonant circuit. In this example, both fixed capacitor Cf and variable capacitor Cv comprise MOS capacitors.

For example, element isolation insulating layer 11 having a shallow trench isolation (STI) structure is formed in p-type semiconductor substrate (e.g. silicon substrate) 10. In semiconductor substrate 10, deep n-well region 12, n-well region 13, n⁺-contact regions 14 and 15, and p-well region 16 are formed.

n-doped polysilicon layer 18 doped with an n-type impurity is formed on n-well region 13 via insulating layer 17. Fixed capacitor Cf comprises n-well region 13, insulating layer 17, and n-doped polysilicon layer 18. n-doped polysilicon layer 20 doped with an n-type impurity is formed on p-well region 16 via insulating layer 19. Variable capacitor Cv comprises p—well region 16, insulating layer 19, and n-doped polysilicon layer 20.

DC-in is connected to gate electrodes (n-doped polysilicon layers) 18 and 20 of MOS capacitors Cf and Cv. Node high is connected to n⁺-contact region 14, and node low is connected to n⁺-contact region 15.

Semiconductor substrate (p-sub) 10 may be fixed to a ground potential or may be electrically floating.

A C (capacitance)-V (output DC voltage) curve of variable capacitor Cv can be obtained when variable capacitor Cv comprises the above-mentioned MOS capacitor (MOS diode). For example, capacitance C of variable capacitor Cv increases with the decrease of the output DC voltage when gate voltage DC-in is negative.

That is, if the output DC voltage drops as compared with Vmax, the output DC voltage acts so that depletion capacitance Cd generated in p-well region 16 disappears (increases). Therefore, capacitance C of variable capacitor Cv increases in the relation of 1/C=1/Cox+1/Cd. Cox is the capacitance of insulating layer 19 between p-well region 16 and n-doped polysilicon layer 20. As capacitance C of variable capacitor Cv increases, the output DC voltage is restored to Vmax.

Taking such a relation into consideration, if the C-V curve of the MOS capacitor at the start of the decrease of Cox is used, the output DC voltage can be always controlled to be Vmax independently of the frequency. The voltage at the start of the decrease of Cox depends on an effective electric field applied to p-well region 16 from gate electrode (n-doped polysilicon layer) 20 of the MOS capacitor via insulating layer 19. This voltage can be adjusted by changing a gate threshold Vth of the MOS capacitor. Vth can be adjusted by changing the impurity concentrations and materials of p-well region 16 and n-doped polysilicon layer 20 of the MOS capacitor.

The voltage fed back to the LC resonant circuit is a DC voltage. Therefore, regarding the MOS capacitors in the LC resonant circuit, fixed capacitor Cf and variable capacitor Cv are connected in series to each other, and the output DC voltage is input to the connection node (floating node) of the capacitors.

Furthermore, in this example, fixed capacitor Cf and variable capacitor Cv are adjacently located on semiconductor substrate 10. Both fixed capacitor Cf and variable capacitor Cv comprise the MOS capacitors. However, the difference therebetween is the conductivity type (impurity species) and concentration of the well region serving as an electrode on the side of semiconductor substrate 10.

The capacitance of fixed capacitor Cf does not need to be changed by the gate voltage, so that fixed capacitor Cf is formed n-well region 13 doped with an n-type impurity. In contrast, variable capacitor Cv is formed on p-well region 16 doped with a p-type impurity. The capacitance of variable capacitor Cv is changed by depletion capacitance Cd which is formed in p-well region 16 and which depends on gate voltage DC-in.

Deep n-well region 12 is formed to electrically insulate fixed capacitor Cf from variable capacitor Cv.

According to this example, fixed capacitor Cf and variable capacitor Cv are formed on semiconductor substrate 10. A rectifier circuit comprising a diode bridge is also formed on semiconductor substrate 10. That is, both the capacitors and the rectifier circuit can be formed by the same CMOS process.

It is preferable that the diode bridge comprises a pn diode or a Schottky diode and uses a low-resistance high-breakdown-voltage element structure. However, the diode bridge can be suitably selected by one of ordinary skill in the art within the designing range inclusive of the following examples and is therefore not described below.

### Second Example

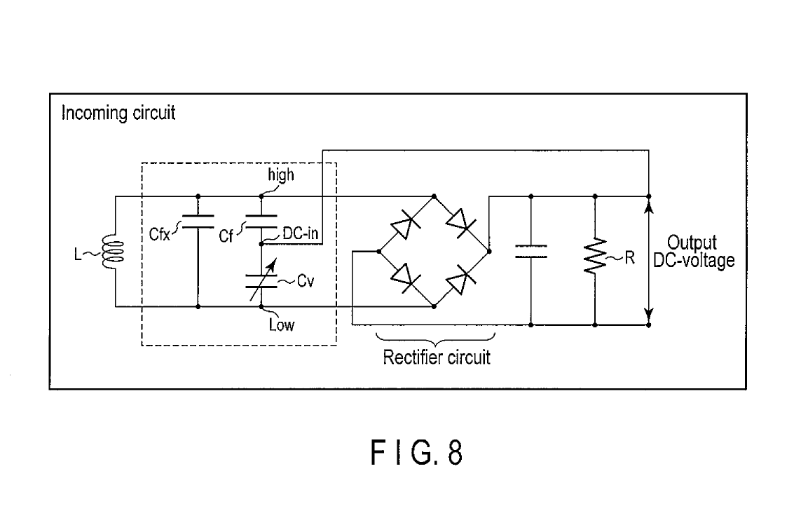

FIG. 8 shows a second example.

The second example is a modification of the first example. Therefore, matters that have already been described in the first example are not described here.

This example is different from the first example in that fixed capacitor Cfx is added in a part indicated by a broken line. Fixed capacitor Cfx is connected in parallel to capacitors Cf and Cv between two nodes high and low.

Fixed capacitor Cfx is added to simplify the design. If the capacitance of fixed capacitor Cfx is set at substantially the same value as the total value of the capacitances of two capacitors Cf and Cv, the correlation between the change of the output DC voltage and the change of the capacitance of variable capacitor Cv can be easier.

The device structure and operation method in the second example are the same as those in the first example. The same device structure as that of fixed capacitor Cf is preferably used for added fixed capacitor Cfx. It is preferable that three capacitors Cf, Cfx, and Cv are formed adjacent to one another on semiconductor substrate 10.

### Third Example

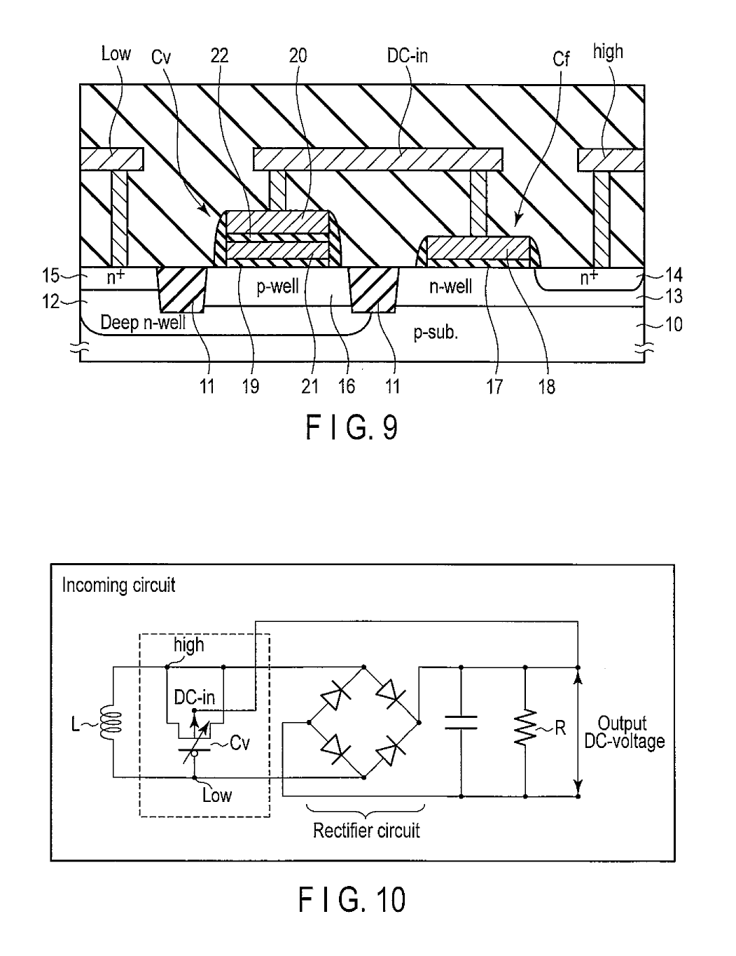

FIG. 9 shows a third example.

The third example is also a modification of the first example. Therefore, matters that have already been described in the first example are not described here.

A circuit diagram in this example is the same as that in the first example (FIG. 6).

This example is different from the first example in that variable capacitor Cv comprises a MOS capacitor of a memory cell structure having charge storage layer 21. Charge storage layer 21 may be a floating gate electrode comprising an electrically floating conductive layer, or may be a trap insulating layer having a charge trapping function.

Charge storage layer 21 is formed on insulating layer 19, and insulating layer 22 is further formed between charge storage layer 21 and gate electrode 20. When charge storage layer 21 is a floating gate electrode, both gate electrode 20 and charge storage layer 21 can comprise, for example, n-doped polysilicon layers doped with an n-type impurity.

According to this device structure, the gate threshold Vth of variable capacitor Cv can be controlled by injecting (writing) a charge into charge storage layer 21 even after the manufacture of the device. As a result, the threshold of variable capacitor Cv can be simply and precisely controlled.

Furthermore, when a method of using an incoming circuit that selectively uses more than one kind of output DC voltage is available, the variation range of the capacitance of the resonant capacitor can be changed by controlling the writing of a charge into the floating gate and switching the mode of the incoming circuit.

Fixed capacitor Cf may also be a MOS capacitor of a memory cell structure having a charge storage layer in the same manner as variable capacitor Cv.

### Fourth Example

FIG. 10 shows a fourth example.

In this example, the LC resonant circuit comprises variable capacitor Cv and coil (inductance) L connected in parallel between two nodes high and low. Variable capacitor Cv comprises a MOS capacitor, and the output DC voltage is input as a back gate bias of the MOS capacitor.

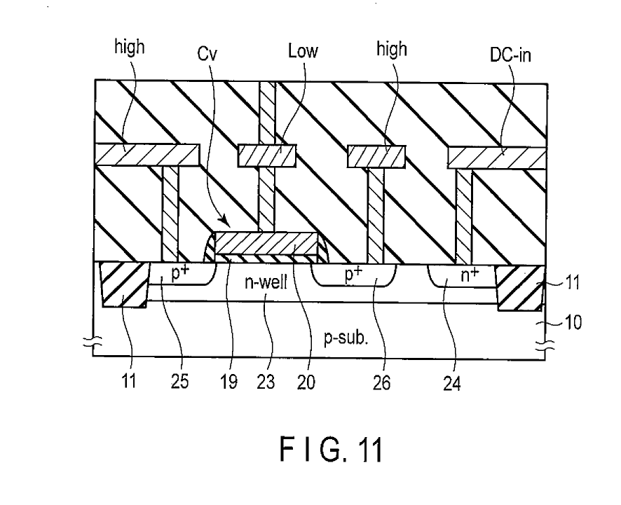

FIG. 11 shows an example of the device structure of a part indicated by a broken line in FIG. 10, that is, variable capacitor Cv that constitutes the LC resonant circuit.

For example, element isolation insulating layer 11 having a shallow trench isolation (STI) structure is formed in p-type semiconductor substrate 10. In semiconductor substrate 10, n-well region 23, n⁺-contact region 24, and p⁺-impurity regions (source/drain) 25 and 26 are formed.

n-doped polysilicon layer (gate electrode) 20 doped with an n-type impurity is formed on n-well region 23 via insulating layer 19. Variable capacitor Cv is a p-channel MOS capacitor comprising n-well region 23, insulating layer 19, n-doped polysilicon layer 20, and p⁺-impurity regions 25 and 26.

DC-in is connected to n⁺-contact region 24 as a back gate bias of variable capacitor (MOS capacitor) Cv. Node high is connected to p⁺-impurity regions (source/drain) 25 and 26, and node low is connected to gate electrode (n-doped polysilicon layer) 20 of variable capacitor Cv.

Semiconductor substrate (p-sub) 10 may be fixed to a ground potential or may be electrically floating.

In this example, the C-V curve of variable capacitor Cv can be obtained by one MOS capacitor. The output DC voltage is directly input to n-well region 23. High of a high-frequency circuit is input to p⁺-impurity regions 25 and 26 as the source/drain of the MOS capacitor. Low of the high-frequency circuit is input to the gate electrode.

According to this device structure, for example, when the output DC voltage is high, the p-channel MOS capacitor is in an off-state (a condition in which no channel is formed), and the capacitance of the MOS capacitor is small.

In contrast, if the output DC voltage drops, the p-channel MOS capacitor is in an on-state (a condition in which a channel is formed), and the capacitance of the MOS capacitor changes to be great. Thus, the output DC voltage is restored to Vmax.

Although variable capacitor Cv is used as the p-channel MOS capacitor in this example, an n-channel MOS capacitor may be used as variable capacitor Cv instead. In each case, an incoming circuit can be formed in accordance with the rule of a normal CMOS process.

### Fifth Example

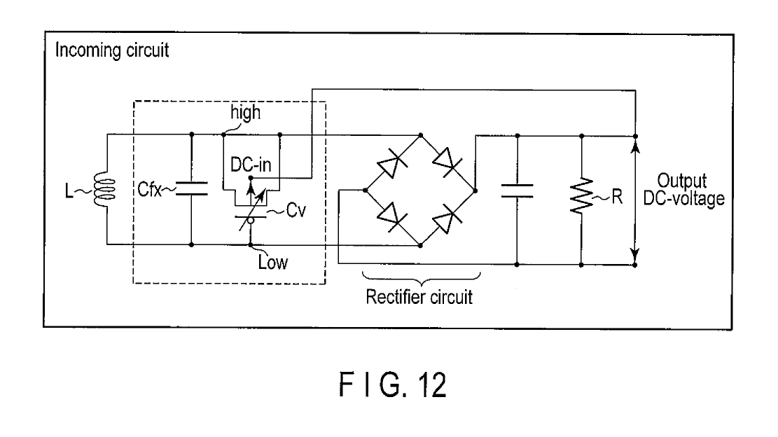

FIG. 12 shows a fifth example.

The fifth example is a modification of the fourth example. Therefore, matters that have already been described in the fourth example are not described here.

This example is different from the fourth example in that fixed capacitor Cfx is added in a part indicated by a broken line. This fixed capacitor Cfx is connected in parallel to variable capacitor Cv between two nodes high and low.

Fixed capacitor Cfx is added to simplify the design by increasing the capacitance of the resonant capacitor when the capacitance of variable capacitor (MOS capacitor) Cv is small. It is preferable that the capacitance of fixed capacitor Cfx and the capacitance of variable capacitor Cv are set to be substantially the same.

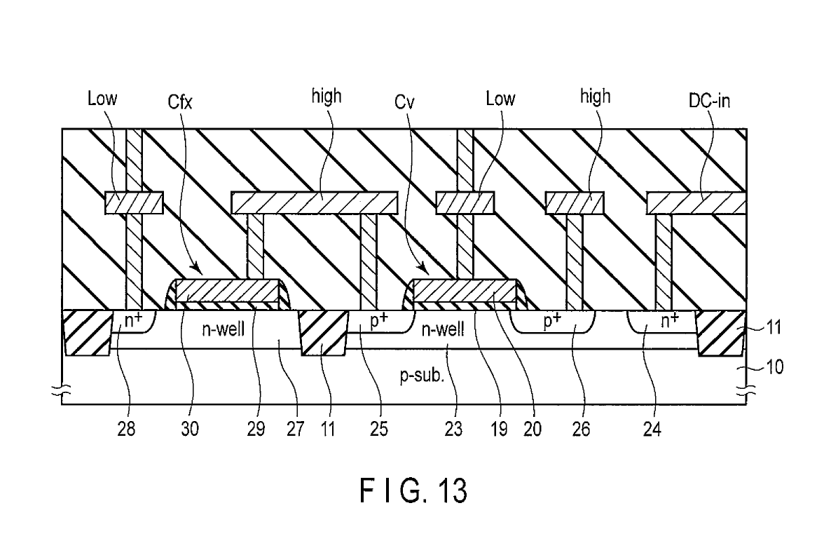

FIG. 13 shows an example of the device structure of a part indicated by a broken line in FIG. 12, that is, capacitors Cv and Cfx that constitute the LC resonant circuit.

Variable capacitor Cv has already been described in the fourth example and is not described here. The device structure of fixed capacitor Cfx is described below.

For example, n-well region 27 and n⁺-contact region 28 are formed in p-semiconductor substrate 10. n-doped polysilicon layer (gate electrode) 30 doped with an n-type impurity is formed on n-well region 27 via insulating layer 29. Fixed capacitor Cfx comprises n-well region 27, insulating layer 29, and n-doped polysilicon layer 30.

Node high is connected to gate electrode (n-doped polysilicon layer) 30 of fixed capacitor Cfx, and node low is connected to n⁺-contact region 28.

The operation method is the same as that in the fourth example and is not described here.

### Sixth Example

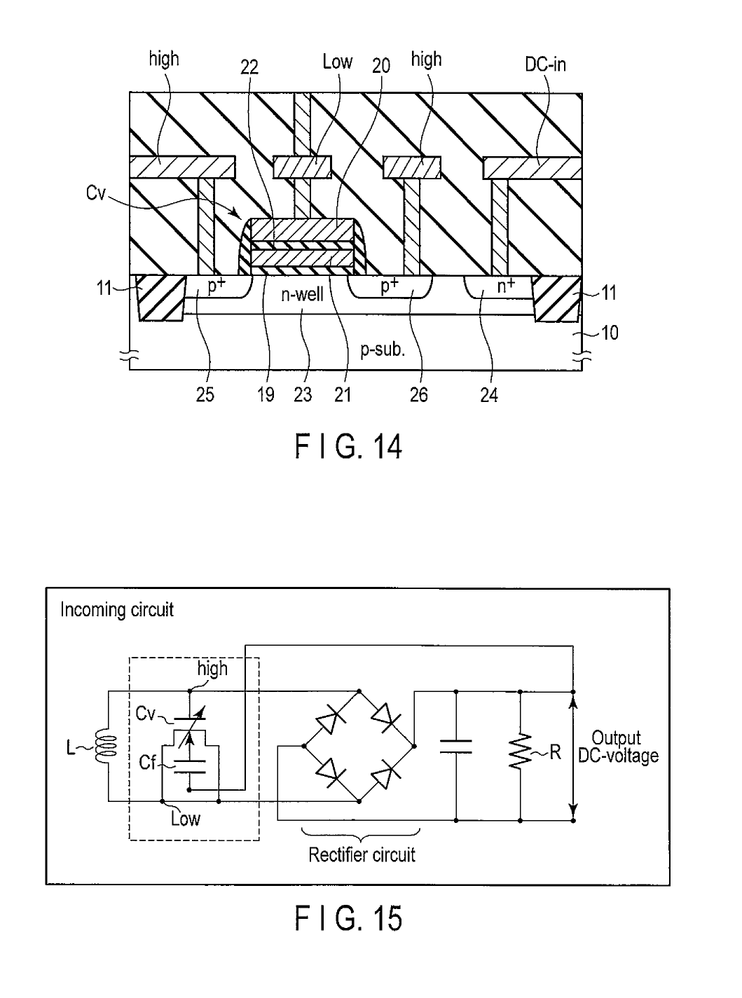

FIG. 14 shows a sixth example.

The sixth example is also a modification of the fourth example. Therefore, matters that have already been described in the fourth example are not described here.

A circuit diagram in this example is the same as that in the fourth example (FIG. 10).

This example is different from the fourth example in that variable capacitor Cv comprises a MOS capacitor of a memory cell structure having charge storage layer 21. Charge storage layer 21 may be a floating gate electrode comprising an electrically floating conductive layer, or may be a trap insulating layer having a charge trapping function.

Charge storage layer 21 is formed on insulating layer 19, and insulating layer 22 is further formed between charge storage layer 21 and gate electrode 20. When charge storage layer 21 is a floating gate electrode, both gate electrode 20 and charge storage layer 21 can comprise, for example, n-doped polysilicon layers doped with an n-type impurity.

According to this device structure, the gate threshold Vth of variable capacitor Cv can be controlled by injecting (writing) a charge into charge storage layer 21 even after the manufacture of the device. As a result, the threshold of variable capacitor Cv can be simply and precisely controlled.

Furthermore, when a method of using an incoming circuit that selectively uses more than one kind of output DC voltage is available, the variation range of the capacitance of the resonant capacitor can be changed by controlling the writing of a charge into the floating gate and switching the mode of the incoming circuit.

### Seventh Example

FIG. 15 shows a seventh example.

In this example, the LC resonant circuit comprises variable capacitor Cv and coil (inductance) L connected in parallel between two nodes high and low. Variable capacitor Cv comprises a MOS capacitor, and the output DC voltage is input as a back gate bias of the MOS capacitor via fixed capacitor Cf.

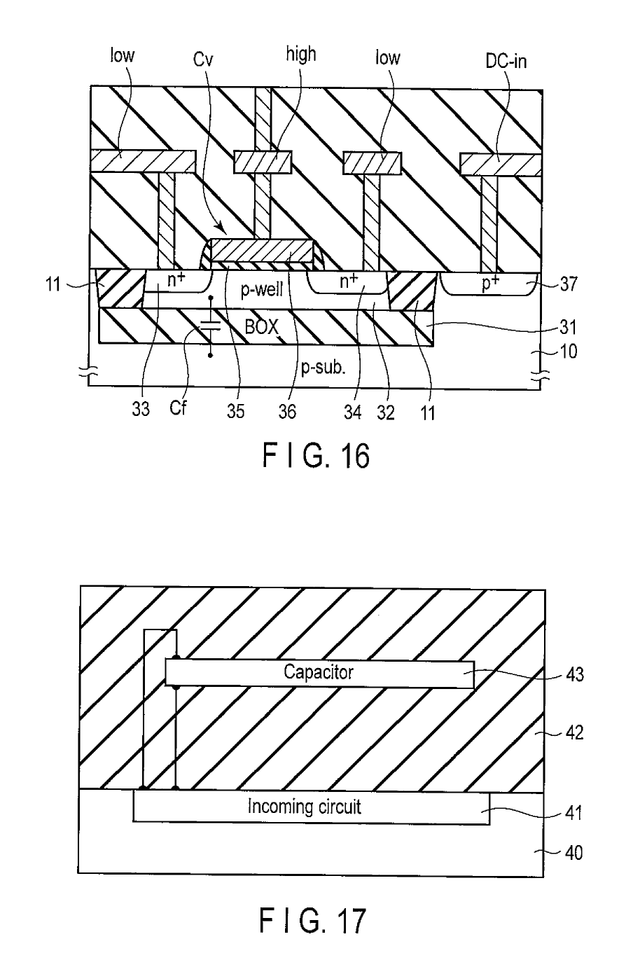

FIG. 16 shows an example of the device structure of a part indicated by a broken line in FIG. 15, that is, a resonant capacitor that constitutes the LC resonant circuit.

For example, element isolation insulating layer 11 having an STI structure and a buried insulating layer (buried oxide [BOX]) 31 are formed in p-type semiconductor substrate 10. P-well region 32 is formed in a region surrounded by these insulating layers. In p-well region 32, n⁺-impurity regions (source/drain) 33 and 34 are formed.

n-doped polysilicon layer (gate electrode) 36 doped with an n-type impurity is formed on p-well region 32 via insulating layer 35. Variable capacitor Cv is an n-channel MOS capacitor comprising p-well region 32, insulating layer 35, n-doped polysilicon layer 36, and n⁺-impurity regions 33 and 34.

DC-in is connected to p⁺-contact region 37 as a back gate bias of variable capacitor (MOS capacitor) Cv.

In this example, the output DC voltage is applied to semiconductor substrate 10 via p⁺-contact region 37. That is, fixed capacitor Cf is formed between semiconductor substrate 10 and p-well region 32, but a well region may be newly formed and the output DC voltage may be applied to this well region when the output DC voltage should not be applied to semiconductor substrate 10.

Node low is connected to n⁺-impurity regions (source/drain) 33 and 34, and node high is connected to gate electrode (n-doped polysilicon layer) 36 of variable capacitor Cv.

In this example, a silicon-on-insulator (SOI) substrate is used, and p-well region 32 in which variable capacitor Cv is formed is surrounded by an insulating layer, thereby preventing the AC voltage side and the output DC side in the incoming circuit from affecting each other. In this case, p-well region 32 is in a floating state. The output DC voltage is applied to the rear side of the SOI substrate, and the output DC voltage is transmitted to p-well region 32 via a capacitive coupling resulting from fixed capacitor Cf, so that the capacitance of variable capacitor Cv can be controlled.

### Eighth Example

FIG. 17 shows an eighth example.

This example concerns the resonant capacitor in the first to seventh examples described above.

Incoming circuit 41 including a resonant circuit is formed in the surface region of semiconductor substrate 40. Incoming circuit 41 is covered with interlayer insulating layer 42. Capacitor 43 used by incoming circuit 41 is formed in interlayer insulating layer 42.

This example is characterized in that the resonant capacitor is formed in interlayer insulating layer 42 on semiconductor substrate 40. The fixed capacitor can be easily formed on the top of semiconductor substrate 40 as a polysilicon capacitor. Regarding the variable capacitor, a semiconductor layer is formed on the top of semiconductor substrate 40, and a variable MOS capacitor is formed in the semiconductor layer.

The semiconductor layer formed on the top of semiconductor substrate 40 is preferably a monocrystalline layer in the same manner as semiconductor substrate 40, but may be a polycrystalline layer.

According to this device structure in this example, the size of capacitor 43 can be easily increased, so that the design can be simplified. Moreover, a coil and a capacitor of an LC resonant circuit do not need to be directly formed on semiconductor substrate 40, thereby preventing the AC voltage side and the output DC side in incoming circuit 41 from affecting each other.

### Ninth Example

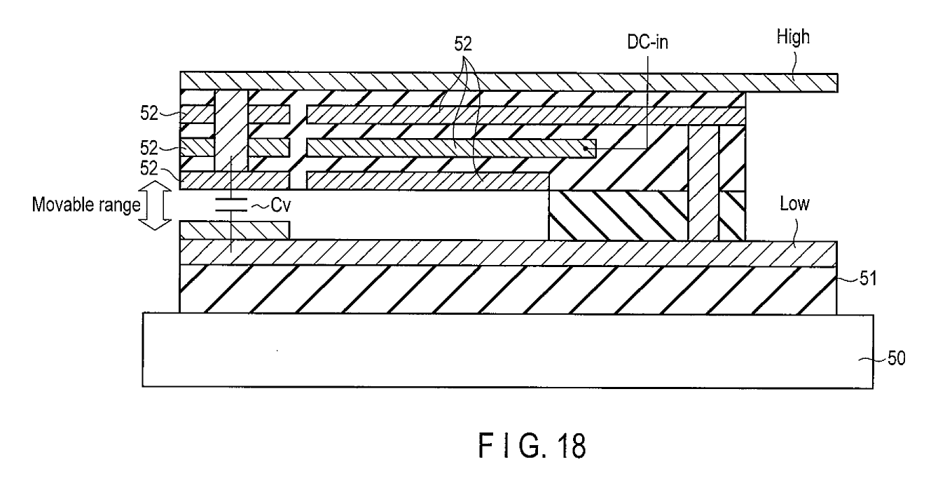

FIG. 18 shows a ninth example.

This example concerns the variable capacitor in the first to seventh examples described above.

This example is characterized in that a micro-electromechanical system (MEMS) technique is used to form variable capacitor (MEMS capacitor) Cv on semiconductor substrate 50.

In FIG. 18, a reference number 51 denotes an insulating layer (e.g. silicon oxide), and a reference number 52 denotes a piezoelectric thin film. High and low denote electrodes. DC-in denotes an output DC voltage.

In this example, piezoelectric thin film 52 has a multilayer structure. Piezoelectric thin films 52 that are stacked are electrically insulated from one another.

The MEMS technique is a technique that uses, for example, mechanical microstructures on a semiconductor substrate to obtain micro-devices such as an actuator, a sensor, and a resonator. When a variable capacitor is produced by the MEMS technique (mechanical structure), characteristics that cannot be easily obtained by the MOS capacitor can be obtained.

The MEMS capacitor is mainly driven by electrostatic force. In this case, an operating voltage of 30 to 50 V, at least 10 V or more is needed. Therefore, the MEMS capacitor is not suited for low-power use. On the other hand, in this example, the MEMS capacitor driven by piezoelectric force can solve the above-mentioned problem of the operating voltage because this MEMS capacitor uses, as driving force, the piezoelectric force of the piezoelectric thin film that can be sufficiently driven even by a low voltage, instead of the electrostatic force that requires a high voltage.

Therefore, if a high-quality piezoelectric thin film having a sufficiently high electromechanical coupling factor (a factor which converts an electric signal to mechanical driving) is formed and the design of the MEMS device structure is optimized, an operating voltage of 3 V or less can be obtained in principle.

For example, lead zirconate titanate (PZT), zinc oxide (ZnO), and aluminum nitride (AlN) can be used for the piezoelectric thin film that constitutes MEMS capacitor Cv. If satisfactory piezoelectric characteristics, compatibility with a semiconductor process, and the stability of the semiconductor process are taken into consideration, aluminum nitride (AlN) is most desirable for the piezoelectric thin film. It is preferable that AlN is formed to have high orientation at a higher formation temperature in order to maximize the piezoelectric performance of AlN.

Furthermore, to be compatible with the semiconductor process, the piezoelectric thin film is preferably a self-assembled film that permits orientation control even at low temperature. Thus, in this example, Al is formed on an amorphous buffer layer, for example, by a sputtering method, and then AlN is formed on Al. This allows a high-quality AlN piezoelectric thin film with high orientation to be formed even at low temperature.

MEMS capacitor Cv in this example is a cantilever type or a bimorph type. In this structure, piezoelectric force can be increased by switching the polarity of a voltage applied across two electrodes high and low. If the voltage applied across two electrodes high and low is controlled, a cantilever is driven in a movable range by piezoelectric force, and the capacitance of MEMS capacitor changes.

When this structure is used, the characteristic that shows the relation between the driving voltage and capacitance of MEMS capacitor Cv has a satisfactory linear shape. For example, maximum capacitance Cmax is obtained at a driving voltage of zero, and minimum capacitance Cmin is obtained at a driving voltage of 5 V. In this case, the capacitance slowly decreases from Cmax to Cmin if the driving voltage is slowly changed from zero to 5 V. When the driving voltage is beyond 5 V, the capacitance is kept at the fixed value Cmin.

The polarity of the driving voltage can be reversed by changing the conditions for the formation of piezoelectric thin film 52.

<Addition>

Although the structure in which the resonant coil and the electromagnetic induction coil are separated is considered in the above explanation, the electromagnetic induction coil is unnecessary in essence if resonance conditions are set in the whole system. That is, a pair of coils enable electric power transmission/reception by the magnetic resonant coupling in principle.

### CONCLUSION

According to the embodiment, it is possible to provide a magnetic resonant coupling incoming circuit and a wireless power supply system that uses this incoming circuit so that the reduction of power transmission efficiency can be prevented by a small-sized and simple configuration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An incoming circuit using a magnetic resonant coupling comprising:
an incoming coil which receives magnetic field energy transmitted from an outgoing coil under conditions of energy power transmission by the magnetic resonant coupling; and
an incoming circuit which comprises a variable capacitor and a rectifier circuit and which outputs, as a direct-current voltage, the magnetic field energy received by the incoming coil,
wherein the magnetic field energy is converted to an alternate-current voltage by the incoming coil and the variable capacitor, and the alternate-current voltage is converted to the direct-current voltage by the rectifier circuit, and
a capacitance of the variable capacitor is automatically controlled to change in an analog form along with the change of the direct-current voltage and to keep the transmission efficiency of the magnetic field energy at a fixed value by directly feeding back the direct-current voltage to the variable capacitor.

2. The circuit of claim 1,
wherein the incoming circuit comprises a first fixed capacitor, the variable capacitor and the first fixed capacitor are connected in series between first and second nodes, the incoming coil is connected between the first and second nodes, and the direct-current voltage is input to a connection node of the variable capacitor and the first fixed capacitor, and
the variable capacitor is a MOS capacitor which comprises a first semiconductor region of a first conductivity type, a second semiconductor region of a second conductivity type, and an insulating region therebetween.

3. The circuit of claim 2,
wherein the incoming circuit comprises a second fixed capacitor connected between the first and second nodes.

4. The circuit of claim 2,
wherein the variable capacitor comprises a charge storage layer between the insulating region and the second semiconductor region.

5. The circuit of claim 1,
wherein the variable capacitor and the incoming coil are connected in parallel between the first and second nodes,
the variable capacitor is a MOS capacitor which comprises a first semiconductor region of a first conductivity type, first and second impurity regions of a second conductivity type in the first semiconductor region, a second semiconductor region of the first conductivity type, and an insulating region between the first semiconductor region located between the first and second impurity regions and the second semiconductor region, and
the first node is connected to the first and second impurity regions, the second node is connected to the second semiconductor region, and the direct-current voltage is input to the first semiconductor region.

6. The circuit of claim 5,
wherein the incoming circuit comprises a fixed capacitor connected between the first and second nodes.

7. The circuit of claim 5,
wherein the variable capacitor comprises a charge storage layer between the insulating region and the second semiconductor region.

8. The circuit of claim 1,
wherein the variable capacitor and the incoming coil are connected in parallel between the first and second nodes,
the variable capacitor is a MOS capacitor which comprises a first semiconductor region of a first conductivity type, first and second impurity regions of a second conductivity type in the first semiconductor region, a second semiconductor region of the second conductivity type, and an insulating region between the first semiconductor region located between the first and second impurity regions and the second semiconductor region, and
the first node is connected to the second semiconductor region, the second node is connected to the first and second impurity regions, the first semiconductor region is completely surrounded by an insulating layer in a semiconductor substrate, and the direct-current voltage is input to the semiconductor substrate.

9. The circuit of claim 1,
wherein the variable capacitor is formed in an interlayer insulating layer on a semiconductor substrate.

10. The circuit of claim 1,
wherein the variable capacitor is a MEMS capacitor formed on a semiconductor substrate.

11. A wireless power transfer system comprising:
an outgoing circuit and an incoming circuit which execute transmitting and receiving electric power under conditions of energy power transmission by a magnetic resonant coupling,
wherein the outgoing circuit comprises an outgoing coil to transmit magnetic field energy,
the incoming circuit comprises
an incoming coil which receives the magnetic field energy, and
a variable capacitor and a rectifier circuit which output, as a direct-current voltage, the magnetic field energy received by the incoming coil,
the magnetic field energy is converted to an alternate-current voltage by the incoming coil and the variable capacitor, and the alternate-current voltage is converted to the direct-current voltage by the rectifier circuit, and
a capacitance of the variable capacitor is automatically controlled to change in an analog form along with the change of the direct-current voltage and to keep the transmission efficiency of the magnetic field energy at a fixed value by directly feeding back the direct-current voltage to the variable capacitor.

12. The system of claim 11,
wherein the incoming circuit comprises a first fixed capacitor, the variable capacitor and the first fixed capacitor are connected in series between first and second nodes, the incoming coil is connected between the first and second nodes, and the direct-current voltage is input to a connection node between the variable capacitor and the first fixed capacitor, and
the variable capacitor is a MOS capacitor which comprises a first semiconductor region of a first conductivity type, a second semiconductor region of a second conductivity type, and an insulating region therebetween.

13. The system of claim 12,
wherein the incoming circuit comprises a second fixed capacitor connected between the first and second nodes.

14. The system of claim 12,
wherein the variable capacitor comprises a charge storage layer between the insulating region and the second semiconductor region.

15. The system of claim 11,
wherein the variable capacitor and the incoming coil are connected in parallel between the first and second nodes,
the variable capacitor is a MOS capacitor which comprises a first semiconductor region of a first conductivity type, first and second impurity regions of a second conductivity type in the first semiconductor region, a second semiconductor region of the first conductivity type, and an insulating region between the first semiconductor region located between the first and second impurity regions and the second semiconductor region, and
the first node is connected to the first and second impurity regions, the second node is connected to the second semiconductor region, and the direct-current voltage is input to the first semiconductor region.

16. The system of claim 15,
wherein the incoming circuit comprises a fixed capacitor connected between the first and second nodes.

17. The system of claim 15,
wherein the variable capacitor comprises a charge storage layer between the insulating region and the second semiconductor region.

18. The system of claim 11,
wherein the variable capacitor and the incoming coil are connected in parallel between the first and second nodes,
the variable capacitor is a MOS capacitor which comprises a first semiconductor region of a first conductivity type, first and second impurity regions of a second conductivity type in the first semiconductor region, a second semiconductor region of the second conductivity type, and an insulating region between the first semiconductor region located between the first and second impurity regions and the second semiconductor region, and
the first node is connected to the second semiconductor region, the second node is connected to the first and second impurity regions, the first semiconductor region is completely surrounded by an insulating layer in a semiconductor substrate, and the direct-current voltage is input to the semiconductor substrate.

19. The system of claim 11,
wherein the variable capacitor is formed in an interlayer insulating layer on a semiconductor substrate.

20. The system of claim 11,
wherein the variable capacitor is a MEMS capacitor formed on a semiconductor substrate.
